(19) United States
(12) Patent Application Publication
(10) Pub. No.: US 2015/0020357 A1
(43) Pub. Date: Jan. 22, 2015

(54) TOOL SET AND DISASSEMBLING TOOL THEREOF

(71) Applicant: Wistron Corporation, New Taipei City (TW)

(72) Inventor: Zhao-Ping Fu, New Taipei City (TW)

(73) Assignee: Wistron Corporation, New Taipei City (TW)

(21) Appl. No.: 14/034,575

(22) Filed: Sep. 24, 2013

(30) Foreign Application Priority Data
Jul. 22, 2013 (CN) 201310308905.0

(51) Int. Cl. B25B 27/06; B21J 15/50

(52) U.S. Cl. CPC B25B 27/062; B21J 15/50
USPC 29/235

(57) ABSTRACT

A tool set includes a disassembling tool and an elastic pin having a disassembly end and disposed through first and second parts. The disassembling tool includes a T-shaped rod and a sleeve member having top and bottom ends. The T-shaped rod penetrates the sleeve member and has first and second screw-rod portions and a handle portion. The first screw-rod portion is screwed into a connecting thread in the disassembly end for fixing the elastic pin to the first screw-rod portion. When the sleeve member is pressed to make the bottom end abut against the first and second parts, the handle portion is rotated in a spiral direction of the connecting thread opposite to that of a guiding thread in the top end to make the second screw-rod portion unscrewed from the sleeve member along the guiding thread for rotating the elastic pin out of the first and second parts.

### BACKGROUND OF THE INVENTION

1. Field of the Invention

The present invention relates to a tool set and a disassembling tool thereof, and more specifically, to a tool set for assembly and disassembly of first and second parts and a disassembling tool thereof.

2. Description of the Prior Art

In general, an elastic pin is a hollow cylindrical sheet with a longitudinal opening and is widely used for riveting two parts. The conventional connection method is to dispose the elastic pin through the rivet holes of the two parts. Accordingly, the elastic pin could utilize its preferable elasticity and high shear resistance to make the two parts connected to each other.

However, since there is no disassembly design applied to the elastic pin and no point of force application on its surface, it causes a problem that the elastic pin could not be extracted from the rivet holes of the two parts. The aforesaid problem not only reduces reusability of the elastic pin, but also causes a user much inconvenience in performing disassembly of two parts which are connected to each other by the elastic pin.

### SUMMARY OF THE INVENTION

An objective of the present invention is to provide a tool set for assembly and disassembly of first and second parts and a disassembling tool thereof to solve the aforesaid problem.

The present invention provides a tool set for assembly and disassembly of a first part and a second part. The first and second parts have a rivet hole respectively. The tool set includes an elastic pin and a disassembling tool. The elastic pin has a disassembly end and is disposed through the rivet hole of the first part and the rivet hole of the second part respectively to make the first part connected to the second part. A connecting thread is formed in the disassembly end. The disassembling tool includes a sleeve member and a T-shaped rod. The sleeve member has a top end and a bottom end. A guiding thread is formed in the top end. A spiral direction of the guiding thread is opposite to a spiral direction of the connecting thread. The T-shaped rod penetrates the sleeve member and has a first screw-rod portion, a second screw-rod portion, and a handle portion. The first screw-rod portion is screwed into the connecting thread for fixing the elastic pin to the first screw-rod portion. The handle portion is rotated in the spiral direction of the connecting thread to make the second screw-rod portion unscrewed from the sleeve member along the guiding thread for rotating the elastic pin out of the rivet hole of the first part and the rivet hole of the second part when the sleeve member is pressed to make the bottom end abut against the first and second parts. A spiral direction of the first screw-rod portion is the same as the spiral direction of the connecting thread, and a spiral direction of the second screw-rod portion is the same as the spiral direction of the guiding thread.

According to the claimed invention, a longitudinal length of the first screw-rod portion is greater than or equal to a longitudinal length of the connecting thread.

According to the claimed invention, a rod diameter of the first screw-rod portion is less than a rod diameter of the second screw-rod portion.

According to the claimed invention, the sleeve member has a skirt portion extending outwardly from the bottom end for abutting against the first part and the second part.

According to the claimed invention, the guiding thread in the top end of the sleeve member is screwed along the second screw-rod portion to make the bottom end and the skirt portion abut against the first part and the second part.

According to the claimed invention, the sleeve member is bell-shaped.

According to the claimed invention, the second screw-rod portion has a threadless section and the sleeve member slides along the threadless section to make the bottom end abut against the first part and the second part.

The present invention further provides a disassembling tool for disassembly of an elastic pin. The elastic pin has a disassembly end and is disposed through a rivet hole of a first part and a rivet hole of a second part respectively to make the first part connected to the second part. A connecting thread is formed in the disassembly end. The disassembling tool includes a sleeve member and a T-shaped rod. The sleeve member has a top end and a bottom end. A guiding thread is formed in the top end. A spiral direction of the guiding thread is opposite to a spiral direction of the connecting thread. The T-shaped rod penetrates the sleeve member and has a first screw-rod portion, a second screw-rod portion, and a handle portion. The first screw-rod portion is screwed into the connecting thread for fixing the elastic pin to the first screw-rod portion. The handle portion is rotated in the spiral direction of the connecting thread to make the second screw-rod portion unscrewed from the sleeve member along the guiding thread for rotating the elastic pin out of the rivet hole of the first part and the rivet hole of the second part when the sleeve member is pressed to make the bottom end abut against the first and second parts. A spiral direction of the first screw-rod portion is the same as the spiral direction of the connecting thread, and a spiral direction of the second screw-rod portion is the same as the spiral direction of the guiding thread.

In summary, the tool set of the present invention adopts the design that the first screw-rod portion is screwed into the connecting thread of the elastic pin and the handle portion is rotated to make the second screw-rod portion unscrewed from the sleeve member for rotating the elastic pin out of the rivet holes of the first and second parts, to solve the prior art problem that the elastic pin could not be extracted from the rivet holes of the parts. In such a manner, the present invention could greatly improve the disassembling convenience and reusability of the elastic pin.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a tool set according to an embodiment of the present invention.

FIG. 2 is a diagram of an elastic pin in FIG. 1 having not been disposed through a first part and a second part yet.

FIG. 3 is a top view of a sleeve member of a disassembling tool in FIG. 1 abutting against the first part and the second part.

FIG. 4 is a partial sectional diagram of the disassembling tool, the first part, and the second part in FIG. 2 along a sectional line 3-3′.

FIG. 5 is a partial sectional diagram of a handling portion in FIG. 4 being rotated in a spiral direction A to rotate the elastic pin out of the first part and the second part.

FIG. 6 is a partial sectional diagram of a disassembling tool being disposed on the first part and the second part via the elastic pin according to another embodiment of the present invention.

### DETAILED DESCRIPTION

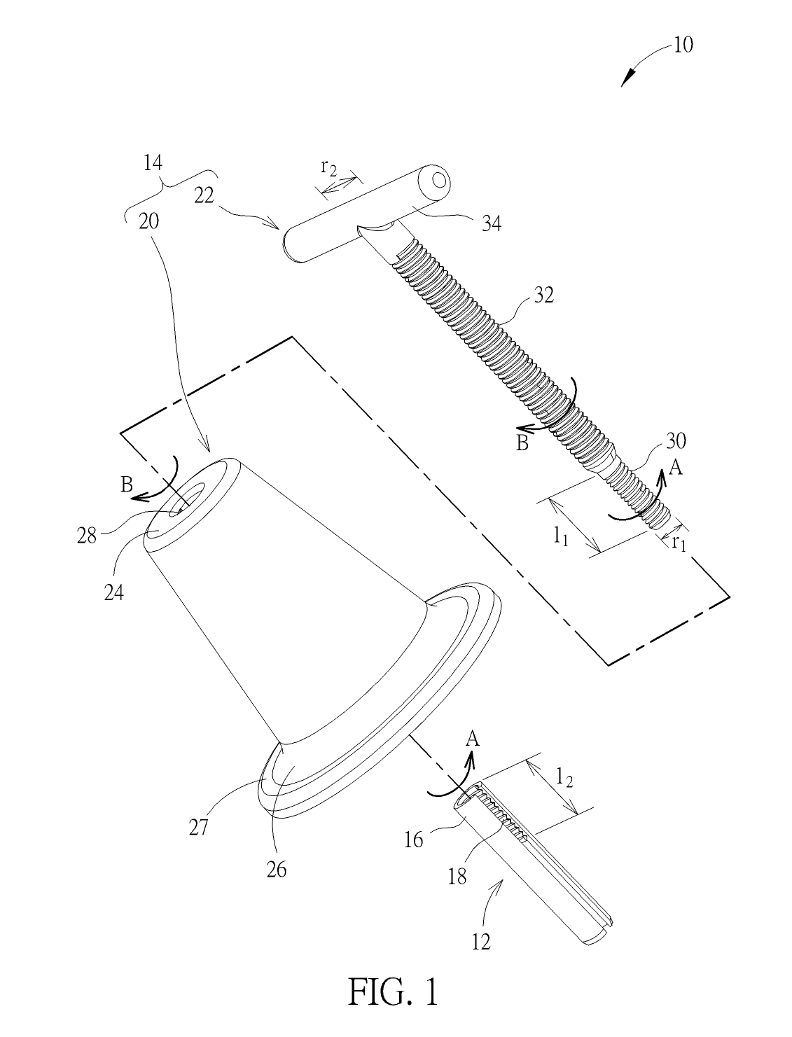

Please refer to FIG. 1, which is an exploded diagram of a tool set 10 according to an embodiment of the present invention. As shown in FIG. 1, the tool set 10 is used for performing assembly and disassembly of two parts. The tool set 10 includes an elastic pin 12 and a disassembling tool 14. The elastic pin 12 could be a hollow cylindrical sheet with a longitudinal opening and have a disassembly end 16. The elastic pin 12 is used for being disposed through rivet holes of two parts to make the two parts connected to each other. A connecting thread 18 is formed in the disassembly end 16.

As shown in FIG. 1, the disassembling tool 14 includes a sleeve member 20 and a T-shaped rod 22. The sleeve member 20 has a top end 24 and a bottom end 26. A guiding thread 28 is formed in the top end 24. A spiral direction A of the connecting thread 18 is opposite to a spiral direction B of the guiding thread 28. To be more specific, in this embodiment, the spiral direction A could be a right-handed spiral direction and the spiral direction B could be a left-handed spiral direction, but not limited thereto. In this embodiment, the sleeve member 20 could be bell-shaped and could have a skirt portion 27 extending outwardly from the bottom end 26 for increasing a support area between the sleeve member 20 and parts desired to be detached by the disassembling tool 14, so that the support strength of the sleeve member 20 could be further increased. The T-shaped rod 22 penetrates the sleeve member 20 and has a first screw-rod portion 30, a second screw-rod portion 32, and a handle portion 34. The first screw-rod portion 30 has the same spiral direction as the connecting thread 18 (i.e. the spiral direction A), and the second screw-rod portion 32 has the same spiral direction as the guiding thread 28 (i.e. the spiral direction B). The first screw-rod portion 30 is used for being screwed into the connecting thread 18 to make the elastic pin 12 fixed on the first screw-rod portion 30. The handle portion 34 is rotated in the spiral direction A of the connecting thread 18 to make the second screw-rod portion 32 unscrewed from the sleeve member 20 along the guiding screw 28 when the sleeve member 20 is pressed to make the bottom end 26 abut against parts desired to be detached by the disassembling tool 14, so as to drive the elastic pin 12 to be rotated out of the rivet holes of the parts.

Furthermore, for making the first screw-rod portion 30 screwed into the elastic pin 12 tightly so that the elastic pin 12 could rotates with the first screw-rod portion 30 when the handle portion 34 is rotated in the spiral direction A of the connecting thread 18 instead of rotating relative to the first screw-rod portion 30, a longitudinal length l₁ of the first screw-rod portion 30 could be greater than or equal to a longitudinal length l₂ (e.g. 6 mm) of the connecting thread 18. In such a manner, the first screw-rod portion 30 could be surely screwed to a bottom end of the connecting thread 18 so as to achieve the purpose that the first screw-rod portion 30 could be screwed into the elastic pin 12 tightly. Furthermore, for preventing the T-shaped rod 22 from damaging the elastic pin 12 by being excessively screwed into the elastic pin 12. A rod diameter r₁ (e.g. 2.5 mm) of the first screw-rod portion 30 could be less than a rod diameter r₂ (e.g. 3.5 mm) of the second screw-rod portion 32, so that the second screw-rod portion 32 could stop the elastic pin 12 for preventing the T-shaped rod 22 from being excessively screwed into the elastic pin 12.

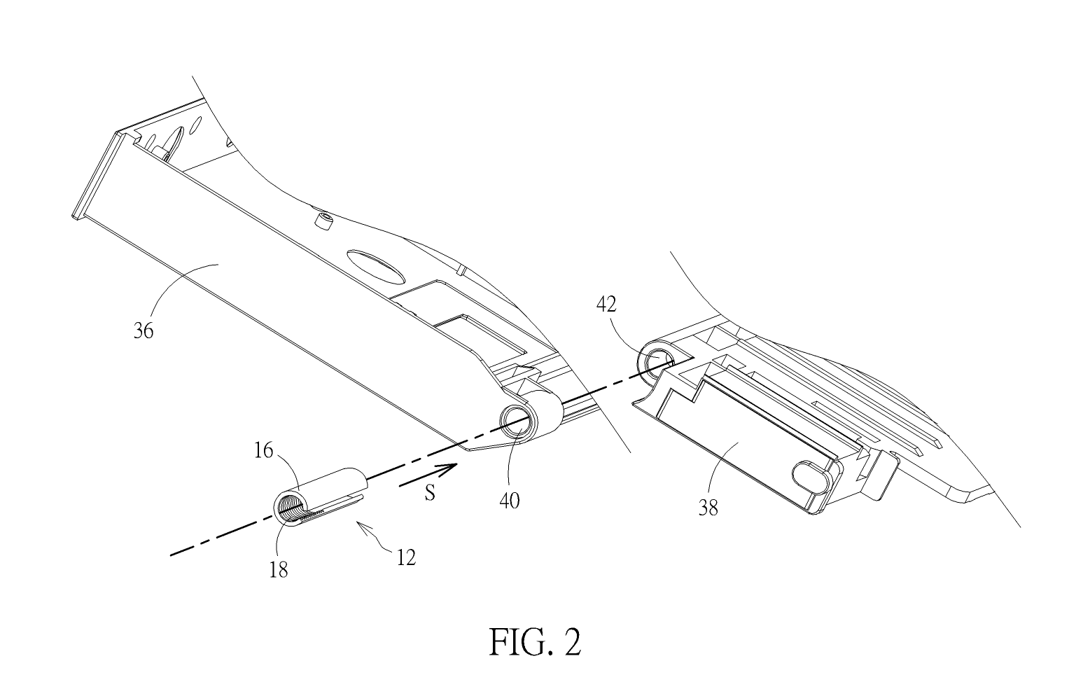

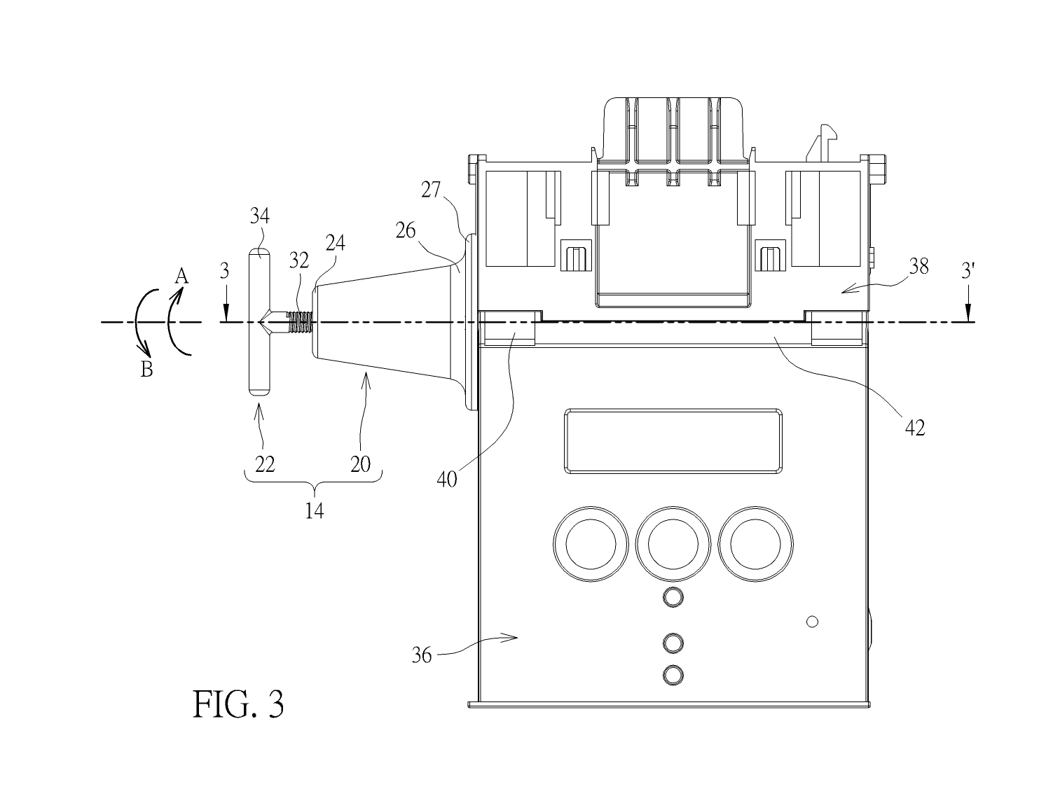

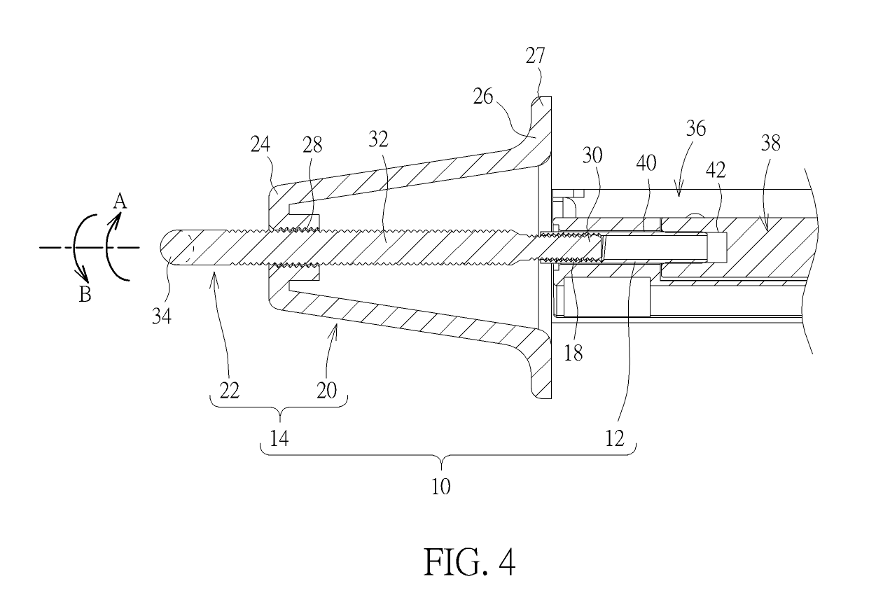

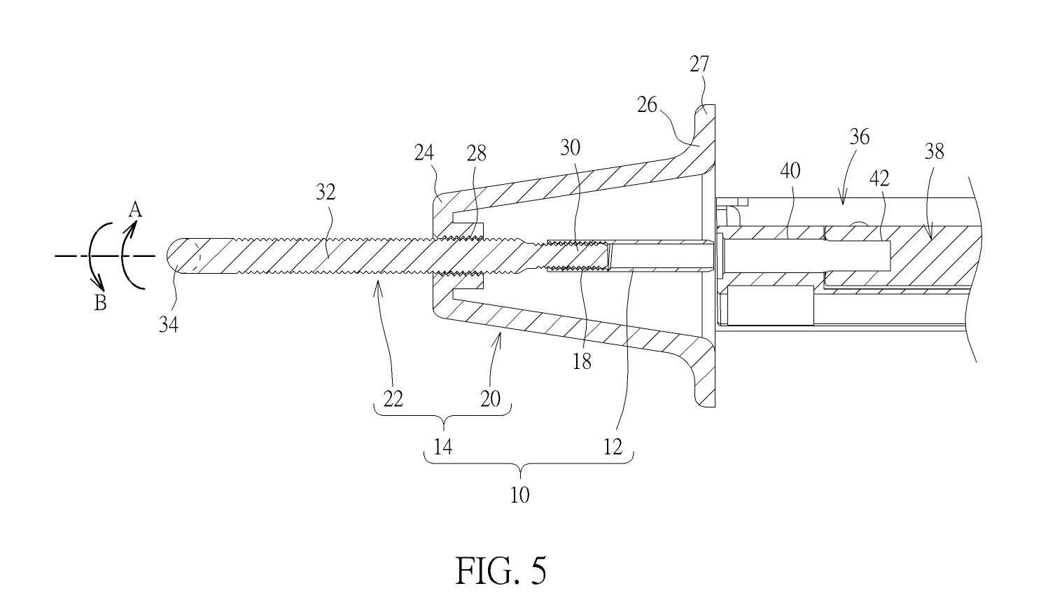

More detailed description for the operation of the tool set 10 is provided as follows. Please refer to FIG. 1, FIG. 2, FIG. 3, FIG. 4, and FIG. 5. FIG. 2 is a diagram of the elastic pin 12 in FIG. 1 having not been disposed through a first part 36 and a second part 38 yet. FIG. 3 is a top view of the sleeve member 20 of the disassembling tool 14 in FIG. 1 abutting against the first part 36 and the second part 38. FIG. 4 is a partial sectional diagram of the disassembling tool 14, the first part 36, and the second part 38 in FIG. 2 along a sectional line 3-3′. FIG. 5 is a partial sectional diagram of the handling portion 34 in FIG. 4 being rotated in the spiral direction A to rotate the elastic pin 12 out of the first part 36 and the second part 38. As shown in FIG. 2, a user could align the elastic pin 12 with a rivet hole 40 of the first part 36 and a rivet hole 42 of the second part 38, and then insert the elastic pin 12 into the rivet hole 40 of the first part 36 and the rivet hole 42 of the second part 38 along an insertion direction S as shown in FIG. 2. Accordingly, the elastic pin 12 disposed through the rivet hole 40 and the rivet hole 42 could utilize its preferable elasticity and high shear resistance to make the first part 36 connected to the second part 38, so as to complete the connecting operation of the tool set 10 for the first part 36 and the second part 38. To be noted, the structural designs of the first part 36 and the second part 38 are not limited to FIG. 2 and FIG. 3. That is, the tool set 10 and the disassembling tool 14 provided by the present invention are suitable for any two parts which could be connected to each other via the elastic pin 12.

On the other hand, if the user wants to utilize the disassembling tool 14 to detach the elastic pin 12 from the first part 36 and the second part 38, the user just needs to perform the operation of disposing the disassembling tool 14 on the first part 36 and the second part 38 (as shown in FIG. 3) in advance. To be more specific, as shown in FIG. 3 and FIG. 4, the user could screw the first screw-rod portion 30 of the T-shaped rod 22 into the connecting thread 18 in the elastic pin 12 in the spiral direction A, so as to fix the elastic pin 12 on the first screw-rod portion 30. Subsequently, the user could rotate the sleeve member 20 in the spiral direction B until the guiding thread 28 in the sleeve member 20 is screwed along the second screw-rod portion 32 to make the bottom end 26 and the skirt portion 27 of the sleeve member 20 abut against the first part 36 and the second part 38 (as shown in FIG. 4). Finally, the user just needs to press the sleeve member 20 to make the bottom end 26 and the skirt portion 27 of the sleeve member 20 abut against the first part 36 and the second part 38 tightly, and then rotates the handling portion 34 in the spiral direction A. In such a manner, the second screw-rod portion 32 could be unscrewed from the sleeve member 20 along the guiding thread 28, so as to drive the elastic pin 12 fixed on the first screw-rod portion 30 to be rotated out of the rivet hole 40 of the first part 36 and the rivet hole 42 of the second part 38. In other words, with rotation of the handling portion 34 in the spiral direction A, the second screw-rod portion 32 could be unscrewed from the sleeve member 20. At the same time, since the elastic pin 12 is fixed on the first screw-rod portion 30, the elastic pin 12 could be accordingly rotated out of the rivet hole 40 of the first part 36 and the rivet hole 42 of the second part 38 from a position as shown in FIG. 4 together with the first screw-rod portion 30. After the elastic pin 12 is completely rotated out of the first part 36 and the second part 38 (as shown in FIG. 5), disassembly of the elastic pin 12 from the first part 36 and the second part 38 is accordingly completed.

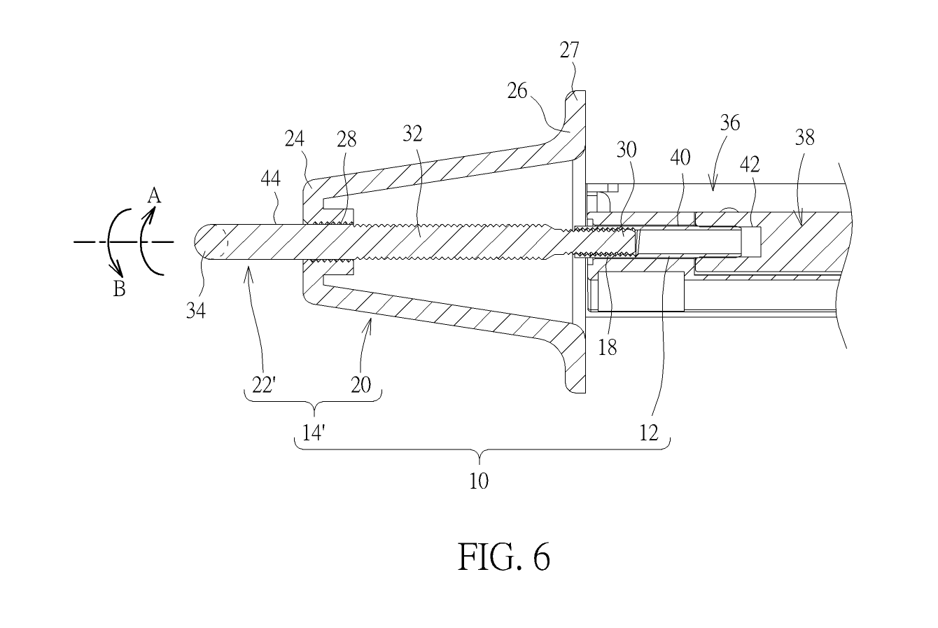

It should be mentioned that the thread design of the second screw-rod portion is not limited to the aforesaid embodiment. Please refer to FIG. 6, which is a partial sectional diagram of a disassembling tool 14′ being disposed on the first part 36 and the second part 38 via the elastic pin 12 according to another embodiment of the present invention. Components both shown in FIG. 6 and the aforesaid embodiment represent components with similar function or structures, and the related description is therefore omitted herein. As shown in FIG. 6, in this embodiment, the disassembling tool 14′ includes the sleeve member 20 and a T-shaped rod 22′. The T-shaped rod 22′ has the first screw-rod portion 30, the handle portion 34, and a second screw-rod portion 32′. The second screw-rod portion 32′ has a threadless section 44. Accordingly, when being pressed, the sleeve member 20 could directly slide along the threadless portion 44 to make the bottom end 26 and the skirt portion 27 of the sleeve member 20 abut against the first part 36 and the second part 38, so as to improve the operational convenience of the tool set 10. As for which design is utilized, it depends on the practical application of the tool set 10.

In summary, the tool set of the present invention adopts the design that the first screw-rod portion is screwed into the connecting thread of the elastic pin and the handle portion is rotated to make the second screw-rod portion unscrewed from the sleeve member for rotating the elastic pin out of the rivet holes of the first and second parts, to solve the prior art problem that the elastic pin could not be extracted from the rivet holes of the two parts. In such a manner, the present invention could greatly improve the disassembling convenience and reusability of the elastic pin.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tool set for assembly and disassembly of a first part and a second part, the first and second parts having a rivet hole respectively, the tool set comprising:
an elastic pin having a disassembly end and disposed through the rivet hole of the first part and the rivet hole of the second part respectively to make the first part connected to the second part, a connecting thread being formed in the disassembly end; and
a disassembling tool comprising:
a sleeve member having a top end and a bottom end, a guiding thread being formed in the top end, a spiral direction of the guiding thread being opposite to a spiral direction of the connecting thread; and
a T-shaped rod penetrating the sleeve member and having a first screw-rod portion, a second screw-rod portion, and a handle portion, the first screw-rod portion being screwed into the connecting thread for fixing the elastic pin to the first screw-rod portion, the handle portion being rotated in the spiral direction of the connecting thread to make the second screw-rod portion unscrewed from the sleeve member along the guiding thread for rotating the elastic pin out of the rivet hole of the first part and the rivet hole of the second part when the sleeve member is pressed to make the bottom end abut against the first and second parts;
wherein a spiral direction of the first screw-rod portion is the same as the spiral direction of the connecting thread, and a spiral direction of the second screw-rod portion is the same as the spiral direction of the guiding thread.

2. The tool set of claim 1, wherein a longitudinal length of the first screw-rod portion is greater than or equal to a longitudinal length of the connecting thread.

3. The tool set of claim 2, wherein a rod diameter of the first screw-rod portion is less than a rod diameter of the second screw-rod portion.

4. The tool set of claim 3, wherein the sleeve member has a skirt portion extending outwardly from the bottom end for abutting against the first part and the second part.

5. The tool set of claim 4, wherein the guiding thread in the top end of the sleeve member is screwed along the second screw-rod portion to make the bottom end and the skirt portion abut against the first part and the second part.

6. The tool set of claim 5, wherein the sleeve member is bell-shaped.

7. The tool set of claim 1, wherein the second screw-rod portion has a threadless section and the sleeve member slides along the threadless section to make the bottom end abut against the first part and the second part.

8. A disassembling tool for disassembly of an elastic pin, the elastic pin having a disassembly end and being disposed through a rivet hole of a first part and a rivet hole of a second part respectively to make the first part connected to the second part, a connecting thread being formed in the disassembly end, the disassembling tool comprising:
a sleeve member having a top end and a bottom end, a guiding thread being formed in the top end, a spiral direction of the guiding thread being opposite to a spiral direction of the connecting thread; and
a T-shaped rod penetrating the sleeve member and having a first screw-rod portion, a second screw-rod portion, and a handle portion, the first screw-rod portion being screwed into the connecting thread for fixing the elastic pin to the first screw-rod portion, the handle portion being rotated in the spiral direction of the connecting thread to make the second screw-rod portion unscrewed from the sleeve member along the guiding thread for rotating the elastic pin out of the rivet hole of the first part and the rivet hole of the second part when the sleeve member is pressed to make the bottom end abut against the first and second parts;
wherein a spiral direction of the first screw-rod portion is the same as the spiral direction of the connecting thread, and a spiral direction of the second screw-rod portion is the same as the spiral direction of the guiding thread.

9. The disassembling tool of claim 8, wherein a longitudinal length of the first screw-rod portion is greater than or equal to a longitudinal length of the connecting thread.

10. The disassembling tool of claim 9, wherein a rod diameter of the first screw-rod portion is less than a rod diameter of the second screw-rod portion.

11. The disassembling tool of claim 10, wherein the sleeve member has a skirt portion extending outwardly from the bottom end for abutting against the first part and the second part.

12. The disassembling tool of claim 11, wherein the guiding thread in the top end of the sleeve member is screwed along the second screw-rod portion to make the bottom end and the skirt portion abut against the first part and the second part.

13. The disassembling tool of claim 12, wherein the sleeve member is bell-shaped.

14. The disassembling tool of claim 8, wherein the second screw-rod portion has a threadless section and the sleeve member slides along the threadless section to make the bottom end abut against the first part and the second part.
